(19) United States
(12) Patent Application Publication
(10) Pub. No.: US 2014/0263143 A1
(43) Pub. Date: Sep. 18, 2014

(54) Articulated Arm Lifting System

(71) Applicant: THE CARPENTER GROUP, San Francisco, CA (US)

(72) Inventors: Dane Oliver, Vallejo, CA (US); Ben Jones, Vallejo, CA (US); Steven J. Bahr, Milpitas, CA (US); Joseph M. Blanco, Lago Vista, TX (US); Jacob E. Cannon, Austin, TX (US)

(73) Assignee: THE CARPENTER GROUP, San Francisco, CA (US)

(21) Appl. No.: 13/842,339

(22) Filed: Mar. 15, 2013

(51) Int. Cl. B66C 23/18; B66C 23/16; B66C 23/90

(52) U.S. Cl. CPC B66C 23/18; B66C 23/90; B66C 23/163
USPC 212/282

(57) ABSTRACT

A lifting system for semiconductor processing equipment utilized in a cleanroom environment. The lifting system comprises of an articulating arm, a base, a load indicator, a capture tool and a wirelessly controlled hoist motor unit with float control. The float control allows precise positioning and movement of the load without requiring use of up and down controls of the wireless remote. Covers and the bellows positioned on and coupled with the arm assembly reduce contamination caused by a wire rope extending from the arm. A load indicator shows the system coming under load while holding the load stationary. A capture tool provides quick release and ease of grabbing the load with the use of a capture pin. A rotary electrical collector provides a full 360 degrees of rotation of the articulating arm from the base, in both directions. This lifting solution provides high cleanliness and ease of use.

### BACKGROUND

1. Field of Invention

This invention relates to an articulated arm lifting system. In particular, a lifting system that is mounted on semiconductor equipment and operates to lift heavy components used to service the equipment.

2. Background

Lifting tools are used to lift and maneuver components to service semiconductor equipment. Components used to service semiconductor equipment are heavy and can weigh up to 125 lbs or more. Some lifting tools have articulated arms to aid reaching, moving and manipulating the components. Manipulating the movements of heavy components with these tools is typically done manually by one or two users and can be restrictive causing longer equipment service time. Users servicing semiconductor equipment have also become injured due to the heavy weight and awkward lifting of the components. Some lifting tools are mobile, providing greater ease in use, but they are large and difficult to move, limiting access when servicing semiconductor equipment. Because of these issues, servicing semiconductor equipment using these lifting tools is awkward and slow.

Accordingly, there is a need for a lifting system to provide a safer, faster and more effective method of lifting and maneuvering heavy components while servicing semiconductor equipment.

### SUMMARY

The lifting system in accordance with an embodiment of the present invention is used to lift and maneuver heavy components for servicing semiconductor equipment in a cleanroom environment. The lifting system includes an articulating arm, a lightweight base, a wirelessly controlled hoist motor unit and a capture tool coupled with a load indicator. The articulating arm provides greater reach and is sealed with covers to minimize contaminants. The base is an aluminum base according to an embodiment of the invention which reduces the weight of the lifting system to ease installation in a cleanroom environment. The hoist motor is controlled wirelessly and incorporates variable speeds and a float control. The float control enables the user to precisely move a load or component up and down without using the hoist controls. It enables the user to maneuver the load without having to lift more than a pound. The load indicator provides a visual indicator of the system coming under load. The capture tool enables quick release and ease of grabbing the load by the capture pin. A rotary electrical collector interfacing the articulating arm and base provides the system a 360 degree range of motion. The greater reach and ease of use of the lifting system according to embodiments of the present invention greatly shortens service time, provides more precise and freedom of movement, increased access for working on equipment, and increases productivity.

These and other aspects of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 is a front perspective view of the lifting system, according to an embodiment of the present invention.

FIG. 2 is a side view of the capturing tool assembly of the lifting system in accordance with an embodiment of the present invention.

FIG. 3A is a cross-sectional view of the capturing tool assembly of FIG. 2, taken along a line 3A-3A of FIG. 3B, according to an embodiment of the present invention.

FIG. 3B is a reduced bottom plan view of the capturing tool assembly, according to an embodiment of the present invention.

FIG. 4 is a perspective top view of the capturing tool assembly of the lifting system according to an embodiment of the present invention.

FIG. 5 is a partial view of the articulating arm joint of the lifting system of FIG. 1, according to an embodiment of the present invention.

FIG. 6A is a perspective cross-sectional view of a rotary interface of the lifting system of FIG. 1, taken along a line 6A-6A of FIG. 6C, according to an embodiment of the present invention.

FIG. 6B is a cross sectional view of the rotary interface taken along the line 6A-6A of FIG. 6C, according to an embodiment of the present invention.

FIG. 6C is a reduced top plan view of the rotary interface, according to an embodiment of the present invention.

FIG. 7 is a top view of the rotary interface and base assembly of the lifting system of FIG. 1, according to an embodiment of the present invention.

FIG. 8A is a perspective cross-sectional view of a mounting post assembly of the lifting system of FIG. 1, taken along a line 8B-8B of FIG. 8C, according to an embodiment of the present invention.

FIG. 8B is a cross-sectional view of the mounting post assembly taken along the line 8B-8B of FIG. 8C, according to an embodiment of the present invention.

FIG. 8C is a reduced top plan view of the mounting post assembly, according to an embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

FIG. 1 is a front perspective view of a lifting system in accordance with an embodiment of the present invention. The lifting system 40 generally includes a capturing tool assembly 42, an arm assembly, a motor 13 and a base assembly 17. In an embodiment of the present invention, the lifting system 40 is mounted to the platform of semiconductor equipment and functions to lift, lower, move and maneuver a component to service semiconductor equipment.

As shown in FIG. 2, the capturing tool assembly 42 or end effector assembly is coupled to one end of the arm assembly. In an embodiment of the present invention, the capturing tool assembly 42 includes a capture tool 1, a load indicator 2 and a bellows 3, as depicted in FIGS. 2 and 3.

The capture tool 1 allows for quick engagement and release of components used to service semiconductor equipment or other load. As shown in FIGS. 3A and 3B, the capture tool 1 utilizes a ball lock mechanism for quick release of a load. The ball lock mechanism uses a rotating lock 24 that rotates to lock a ball 25 into a bore 43. When in use, the locking ball 25 locks a capture pin (not shown) into the shaft 44 of the capture tool 1. Capture pins, present on the load to be lifted, provide a secure connection for the lifting system 40 to capture and lift a load. The locking ball 25 is spring loaded to provide a constant force to hold and secure the capture pin in the shaft 44. This is a safety feature that prevents the capture pin, and hence the load, from being released while under load.

To release the capture pin, the rotating lock 24, as shown in FIG. 3A, is rotated to release the locking ball 25 from the bore 43 of the shaft 44, allowing the capture pin to slide out. Other locking assemblies may also be used to capture and secure a load.

The load indicator 2, as shown in FIG. 1, provides the user with a visual indicator of the arm assembly coming under load as the lifting system engages a load. In an embodiment of the present invention, the load indicator 2 includes an outer body and a swivel assembly. The outer body includes a cylindrical tube 22 made from a clear acrylic material. In one embodiment, the cylindrical tube 22 is clear in its entirety and serves as a window providing a visual access to the swivel assembly. In another embodiment, the cylindrical tube may be partially clear. The swivel assembly includes a rotating tube 23, a load indicator plate 29, a clevis 28, a swivel pin 30 and a securing pin 45.

The outer body of the load indicator 2 contains a threaded hole centered on its bottom face. The capture tool is attached to the load indicator 2 through this hole by a threaded stud 27, as shown in FIG. 3A. The swivel assembly sits inside the cylindrical tube 22 and rotates with a bearing. The capture tool flange 26 (which is welded to the capture tool 1) attaches the capture tool 1 to the outer body 22.

As shown in FIG. 4, the top portion of the clevis 28 extends through the load indicator plate 29. The load indicator plate 29 is shaped such that the center portion of the plate is cut out and fits between the prongs 46 over the clevis 28. A wire rope or cable 47, extending from the arm member 5, is attached to the swivel pin 30. The wire rope 47 has a twisted spring-like design. The twisted design causes the strands of the wire rope 47 to unwind and straighten when a load is applied. This unwinding while under load causes the wire rope 47 to rotate. The force or rotation of the wire rope 47 causes the same rotation in the clevis 28, also rotating the indicator plate 29 and rotating tube 23, and hence, the entire swivel assembly rotates in a parallel manner. For example, when the wire rope rotates in a counterclockwise direction upon engaging a load, the clevis 28, indicator plate 29 and rotating tube 23 will rotate in a parallel manner. This rotation in the wire rope 47 can then be seen from the rotation of the swivel assembly. In one embodiment of the invention, as shown in FIG. 2, the rotating tube 23 of the swivel assembly contains a striped design. The striped design spins when the wire rope 47 spins, indicating that the system is coming under load. The indicator will rotate until the load is lifted and comes to equilibrium.

The wire rope extending between the arm assembly and the load indicator assembly 2 is protected with a bellows 3, as shown in FIGS. 1, 2 and 3. The bellows 3 is mounted to the arm member 5 with a support plate 4, as shown in FIG. 1. The bellows 3 encloses the wire rope 47, preventing contaminates from being released from the end of the arm member 5 onto the load.

As shown in FIG. 1, the arm assembly generally includes an arm member 5 and a boom member 6. Coupled to the boom member 6 is a mast 15 with a cover plate 15a.

In an embodiment of the present invention, the arm member 5 and the boom member 6 are sealed. Metal caps are welded to the ends of the arm and boom members 5, 6 to seal off the tubes. The only holes in the arm and boom members are threaded holes for bolting covers 9, 10, 11. The arm and boom members 5, 6 are completely sealed from end to end except for these bolt holes. These bolt holes are covered by the bolts that secure the covers 9, 10, 11.

The arm member 5 is covered with a front cover 9 and an arm cover 10. The boom member 6 is covered with a boom cover 11. Each cover 9, 10, 11 is formed from stainless steel and is bolted to the arm member 5 or boom member 6. A large portion of the arm member 5 and boom member 6 is covered by covers 9, 10, 11. In an embodiment of the invention, as shown in FIG. 1, only approximately one foot of the arm member 5 and boom member 6, closest to the elbow of the arm assembly, is uncovered. Bumpers 7 are added to the arm member 5 to prevent it from hitting the boom member 6. This prevents any resulting contamination caused from the arm member 5 and boom member 6 colliding.

The elbow of the arm assembly, as shown in FIG. 5, is constructed with a bearing 48 and a socket head cap screw 49 holding the bearing 48 in place. Shim plates 8 are also added to provide a surface for the bearing 48 to roll on, further preventing contaminates.

In one embodiment of the present invention, the articulating arm has a ten foot reach, allowing it to reach the component to be lifted onto the semiconductor equipment it is mounted to. This reach also allows the arm assembly to reach outside the extent of the semiconductor equipment to set the lifted component down where it is needed. For example, the ten foot reach of the arm assembly allows a lifted component to be placed on a working cart instead of the floor. This is critical when work is done in a class 1000 clean room.

The motor assembly, as shown in FIG. 1, enables a load to be hoisted up or down. It includes a wireless hoist motor unit 13 and a cover plate 12 which shields the inside of the motor unit 13 and keeps any contamination from exiting. The cover plate 12 is positions on the front of the hoist motor unit 13 where the wire rope 47 exits the motor unit 13. This further prevent contaminates that could be caused by the wire rope 47 or the hoist motor unit 13 from being released. The cover plate 12 is also attached to the boom cover 11 so that portion of the lifting system from the motor unit 13 to the end of the boom cover 11 is fully contained. This prevents contaminates and maintains a high level of cleanliness.

The hoist motor unit 13 includes wireless receivers 14 to allow for wireless control of the lifting system 40. Wireless receivers 14 are mounted under the cover of the hoist motor unit 13 so that they are contained within the unit and not directly visible to the user. The receivers are integrated into the motor unit 13 without having to add an external box to house these receivers. The up/down controls of the hoisting function of the motor unit 13 are controlled by a wireless remote or transmitter. This allows the user the freedom to move about when operate the hoisting function without being encumbered by wires.

The hoist motor unit 13 has variable speeds and is equipped with force sensors and a float control. The float control allows the user to manually raise and lower the load without having to lift more than a pound. It allows the user to move the secured load up/down independently of the up/down controls of the wireless remote for the hoisting function. The float mode provides for very precise movement, control and alignment of the load being lifted.

In an embodiment of the invention, the float control is activated by a toggle switch on the wireless receiver 14. Once activated, the weight of the lifted load is calibrated by the hoist motor unit 13. Any change in this calibrated weight while in float mode causes movement of the load. If there is no change in the weight, the load remains static. The motor unit 13 senses the extra weight or force applied by the pushing up or pulling down of the load, and moves the load in the direction of the applied force. The side movements are also achieved by applying horizontal force to the calibrated load. The user can use the float control to move the load in any direction that is needed.

Once the float control is toggled, the user can move the lifted load by hand independent of the wireless remote or any other controls. The user can move the load at any desired speed, and rotate and align the load into any needed orientation all without the need for using up/down controls.

The collector assembly 16 is a rotating electrical connector which allows the arm assembly to rotate 360 degrees or more in either direction on a horizontal plane around an inner ring bearing 51 and an outer ring bearing 50. As shown in FIGS. 6A, 6B and 6C, the collector assembly 16 generally includes a collector tube 33, a collector plate 31, a strain relief bushing 32, and a collector 35. The collector tube 33 is centered over and welded to the collector plate 31. The strain relief bushing 32 is positioned in the center of the collector plate 31. This strain relief bushing 32 holds the power cable from the hoist motor unit 13 in place. The collector plate 31 is fixed relative to the outer ring of the bearing 50 so the bottom of the collector 35 is stationary. The top of the collector 35 rotates and moves relative to the inner ring of the bearing 51. The collector 35 sits inside of the collector tube 33 and is held in place by three fasteners such as set screws 34. In an embodiment, the collector 35 is secured by a plurality of fasteners. A rotating top and stationary bottom of the collector 35 allows one end of the power cable to rotate with the rotation of the arm assembly, while the other end remains fixed. This allows the user freedom to utilize the lifting system 40 without being restricted by the power cable.

As shown in FIGS. 6A and 6B, the inner ring bearing 51 and outer ring 50 bearing interface the base assembly 17 to the arm assembly.

The base assembly 17, shown in FIGS. 1 and 7, generally includes a body 41, leg members 52, feet members 53 and mounting post assemblies 21. In an embodiment of the invention, handles 18 are attached to the base assembly 17 to provide user safety and better maneuverability around the base while working on top of the semiconductor equipment.

In one embodiment, the base assembly 17 includes a horizontal member positioned below the body 41. The bottom edge of the horizontal member is a routed edge 19, as shown in FIG. 1, eliminating any sharpness of the edge and allowing room for wires, if needed.

In another embodiment of the invention, the base assembly 17 is made out of a lightweight metal such as aluminum to reduce the overall weight of the lifting system 40. This eases the installation of the lifting system 40 in a clean room environment.

One or more mounting posts 21 connect and secure the lifting system 40 to the semiconductor equipment. The mounting posts 21 are welded to the feet members 53 of the base assembly 17, as shown in FIGS. 1 and 7. A mounting block 38, housed within the mounting post 21, is removable.

In mounting the lifting system 40, the mounting block 38 is first attached onto the semiconductor equipment. The mounting posts 21 are then fit over the mounting blocks 38. The threaded holes 39, on the front and sides of the mounting blocks 38, are then aligned with the holes on the faces of the mounting posts 21, as depicted in FIGS. 8A, 8B and 8C. In one embodiment, there are three faces that have the holes. The mounting blocks 38 are then bolted to the mounting posts 21 using these holes 39. This allows for ease of installation and adjustments in positioning if necessary. In an embodiment the mounting post 21 is secured to the mounting block 38 by a plurality of fasteners. In another embodiment, there are at least three fasteners.

A threaded hole 20 on top of the mounting post 21 receives a screw to be threaded into the mounting block 38 to secure the base after the mounting post 21 is fitted over the block 38. In one embodiment, the threaded hole 20 follows NPT (National Pipe Thread Standard).

In another embodiment, the threaded hole 20 is large enough to accommodate a screw driver to fit through the hole 20 to tighten the mounting bolt 36. The mounting bolt 36 may contain a socket requiring an allen screw drive.

As shown in FIGS. 8A and 8B, the mounting bolt 36 holds the mounting block 38 in place, attaching the lifting system 40 to semiconductor equipment or any other tool. The inside edge of the mounting post 21 and the top face of the mounting block 38 are chamfered to allow for ease of installation.

In one embodiment, the base assembly 17 is designed to allow the chamber lids of the semiconductor equipment to fully open. As illustrated in FIG. 7, the base assembly 17 is designed to allow for clearance of the bigger lids between the longer distanced leg members 52 and clearance of smaller lids between the shorter distanced leg members 52. For example, the main lid of semiconductor equipment fits in the longer distanced area on both sides of the base assembly 17 and the angle of the leg members 52 accommodate for the opening and closing of the main lids.

In one embodiment, as illustrated in FIG. 7, the span of the leg and feet members 52, 53 of the base assembly 17 is 32.5×43.5 inches. In this example, the lifting system 40 stands approximately 68 inches tall, from the bottom of the feet members 53 to the top.

In other embodiments, the base assembly is modified to fit other mounting configurations. For example, the base assembly may provide three leg members for mounting. Alternatively, the base assembly may provide a base plate configuration for mounting. The base assembly may be customized to fit whatever mounting configuration of the tool the lifting system will be mounted to.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments or alternatives of the foregoing description.

We claim:

1. A lifting system comprising:
a capturing assembly coupled to a distal end of an articulated arm;
a powered hoisting motor connected to a proximal end of the articulated arm; and
a base assembly coupled to the proximal end of the articulated arm, said base assembly comprising a plurality of leg members, each leg member includes a mounting assembly;
said capturing assembly further comprising a wire rope and a load indicator coupled to a capturing tool, wherein said wire rope extends from the articulated arm to the load indicator;
said load indicator further comprising an outer tube, an inner tube, and a clevis, where the clevis is housed within the inner tube and the inner tube is housed within the outer tube, wherein said clevis rotates in parallel with the wire rope as a weight of a load is being lifted;
wherein said hoisting motor is configured to lift a load, calibrate the weight of the load, maintain the calibrated load in a static position, and for an external manual force applied to the load, move the load in a direction of the external force; and
wherein the articulated arm is configured to rotate at least 360 degrees on a horizontal plane around the base assembly.

2. The system of claim 1, wherein the capturing assembly further comprises a bellows that is attached to the load indicator and the capturing tool, said bellows enclosing the wire rope and preventing contaminants from exiting the capturing assembly.

3. The system of claim 1, wherein said hoisting motor is controlled with a wireless remote device.

4. The system of claim 1, wherein the external force is less than one pound.

5. The system of claim 3, wherein the base assembly further comprises four leg members.

6. The system of claim 4, wherein the articulated arm rotates in both a clockwise and counter-clockwise direction.

7. The system of claim 1, wherein the base assembly is made of aluminum.

8. The system of claim 7, wherein each mounting assembly further comprises a mounting post and a mounting block, said mounting post configured to be secured to the mounting block by a plurality of fasteners.

9. The system of claim 7, wherein the base assembly further comprises at least one handle and a horizontal member located at a bottom face of the base assembly, said horizontal member having a routed edge.

10. The system of claim 6, wherein the articulated arm further comprises an arm member, and a boom member, said arm member and boom member sealed with covers to prevent containments from exiting the arm member and boom member.

11. A lifting system for servicing semiconductor equipment comprising:
a capturing tool coupled to a load indicator;
an articulated arm comprising a proximal end and a distal end, said distal end of the articulated arm coupled to the load indicator;
a motor coupled to the proximal end of the articulated arm; and
a base assembly coupled to the proximal end of the articulated arm;
the load indicator further comprises a wire rope and an outer tube that houses an inner tube coupled to a clevis, where the wire rope rotates for a weight of a load being lifted, causing the clevis and the inner tube to rotate;
wherein the articulated arm is configured to rotate at least 360 degrees on a horizontal plane around the base assembly and the base assembly further comprises a plurality of leg members each coupled with a mounting assembly; and
wherein said motor is configured to calibrate the weight of a load, maintain the load in a static position, and when an external force is applied to the load, move the load in a direction of the external force.

12. The system of claim 11, wherein the inner tube comprises a visual indicator of the capturing tool lifting the weight of the load.

13. The system of claim 11, wherein the load indicator is positioned above the capturing tool.

14. The system of claim 11, wherein the load indicator is positioned above the capturing tool and the wire rope is housed by a bellows.

15. The system of claim 12, wherein the visual indicator are stripes.

16. The system of claim 11, wherein the capturing tool is a spring-loaded ball lock.

17. The system of claim 13, wherein the external force is at most one pound.

18. The system of claim 13, wherein the base assembly further comprises four leg members.

19. The system of claim 11, wherein the base assembly further comprises a body, and each leg member is configured to elevate the body such that the body of the base assembly stands on the leg members.

20. The system of claim 11, wherein the motor is further configured to hoist the load up and down.
